(19) United States
(12) Patent Application Publication
(10) Pub. No.: US 2007/0022387 A1
(43) Pub. Date: Jan. 25, 2007

(54) Media management system

(76) Inventors: Theodore Mayer III, Valley Village, CA (US); Zahir Yilmaz Alpaslan, Los Angeles, CA (US)

Correspondence Address: CHRISTIE, PARKER & HALE, LLP, PO BOX 7068, PASADENA, CA, 91109-7068, US

(21) Appl. No.: 11/523,404

(22) Filed: Sep. 18, 2006

Related U.S. Application Data
(63) Continuation-in-part of application No. 10/170,871, filed on Jun. 13, 2002, now Pat. No. 7,139,981.
(60) Provisional application No. 60/297,973, filed on Jun. 13, 2001.

(51) Int. Cl. G06F 9/00; G06F 3/00

(52) U.S. Cl. 715/771; 715/835; 715/810; 715/838

(57) ABSTRACT

A method of configuring a media facility having at least one media source, an output device having one or more output windows, and a media integration system having a media space icon, the method comprising: generating a first icon representing the at least one media source, the at least one media source having an output configured to be coupled to an input of the output device through the media integration system, encrypting characteristics of said at least one media source in the first icon, selecting the first icon, applying the selected first icon to the media space icon to provide the output of the at least one media source to the input of the output device through the media integration system, generating a window icon on the media space icon, the window icon representing one of the one or more output windows, encrypting characteristics of the output window and/or the output device in the window icon, and displaying the first icon and the window icon on a display device.

### CROSS-REFERENCE TO RELATED APPLICATION(S)

The present application is a continuation-in-part of U.S. patent application Ser. No. 10/170,871 filed Jun. 13, 2002, entitled “Media Management System,” which claims priority to and the benefit of U.S. Provisional Application No. 60/297,973 filed Jun. 13, 2001 entitled “Media Management System,” the entire contents of both applications are fully incorporated by reference herein.

### FIELD OF THE INVENTION

The present invention is related to media management, and particularly to a method and apparatus for a menu driven system for directing audio/video sources to sound/display systems and specifically to windows within that sound/display system.

### BACKGROUND

Today, complex, media rich environments such as visualization centers, command and control facilities, emergency response centers, media auditoriums, planning centers and even media based conference rooms are becoming more and more commonplace and complex.

It is typical in these media environments that many media sources become part of the user's information mix. Thus, a media management system is required to route and configure the media components to the proper output devices or to properly configure the output devices to the media components.

Sources may include one or more of various computers, VCRs, cable and satellite feeds, audio sources, DVD players, video servers, cameras, sensors, MP3 players, microphones, and more.

The outputs devices may include one or more of video projectors, monitors, flat panels, control monitors, audio systems, televisions, LCDs (liquid crystal displays), PDPs (plasma display panels), and more. This quickly becomes a very complex management matrix as users require the ability to send each media source to any output device with impunity.

Each media source typically has particular characteristics including the number of horizontal and vertical pixels, the image frame rate, the analog or digital nature of the signal, image processing devices, associated audio source, and with new multi-channel computer sources, how many channels comprise the image.

Each output device typically also has particular characteristics, which can include its native number of vertical and horizontal pixels, multiple inputs, associated image processing devices as well as other adjustments to the type of signal that is sent to it. Often the output device has to have multiple recall memories for multiple signal types.

Any media source can be made compatible with the display characteristics or audio characteristics of the output device. Alternately, any output device can be made compatible with the display characteristics or audio characteristics of the media source.

A single facility could have dozens of display and audio playback systems being fed by dozens of sources.

It is common to use a device called a matrix switcher which allows any input to be routed to any output electronically. These matrix switchers or routers can be very large with an array of possible combinations. A 16 input by 16 output matrix switcher for video and audio offers over 65,000 combinations. As stated above, if some sources and some displays are multi-channel systems, the selection of proper combinations becomes very confusing and complex.

The problem becomes exacerbated when the users of these systems are not media experts, but simply users who wish to get a result. Bringing a multi-channel computer onto a multi-channel display may comprise a sequence such as:

1. Route output 1 from the computer to the left screen;

2. Route output 2 from the computer to the center screen;

3. Route output 3 from the computer to the right screen;

4. Route output 2 from the computer to the control monitor;

5. Switch the left screen projector to the correct signal preset;

6. Switch the center screen projector to the correct signal preset;

7. Switch the right screen projector to the correct signal preset;

8. Route the audio from the computer to the main sound system;

9. Set the volume control of the audio to the proper level;

10. Modify the signal processing recall of output 1 (for systems such as edge blending);

11. Modify the signal processing recall of output 2 (for systems such as edge blending); and

12. Modify the signal processing recall of output 3 (for systems such as edge blending).

Exemplary edge blending systems are described in U.S. Pat. No. 4,974,073 entitled “Seamless Video Display,” U.S. Pat. No. 5,136,390 entitled “Adjustable Multiple Image Display Smoothing Method and Apparatus” and U.S. Pat. No. 6,115,022 entitled “Method and Apparatus for Adjusting Multiple Projected Raster Images,” the contents of each of which are incorporated by reference herein.

More complexity is added if at the same time other systems need to be turned off, or if the computer needs to be reset into a special mode.

In the past, one would assist the user in achieving results more simply by providing a computer control for the various components and then scripting complex sequences into presets. This scripting limits the user to ideas that have been pre-agreed on and thus programmed. Such conventional control systems with pre-configured scripting are available, for example, from AMX Corporation of Richardson, Texas or Crestron Electronics, Inc. of Rockleigh, New Jersey.

### SUMMARY

The present invention relates to a media management system. In one embodiment, the invention relates to a method of configuring a media facility having at least one media source, an output device, a window processing system having one or more output windows, and a media integration system having a media space palette that represents an output device, the method including generating a first icon representing the at least one media source, the at least one media source with an output, which is configured to be displayed in a window of the output device through the window processing system, encrypting characteristics of said at least one media source and the desired characteristics of the resulting display window in the first icon, selecting the first icon, applying the selected first icon to the media space icon, this including the encrypted instructions for showing the desired window on the display device using the media integration system and window processor, generating an icon representing that window on the media space icon, and displaying the first icon, the generated window icon and the media space icon on a display device.

In another embodiment, the invention relates to a media management system suitable for configuring a media facility, said system including a media source, a window processing system, an output device, and an integration system coupled to the media source, the window processing system, and the output device, said integration system having a display device configured to display a first icon representing the media source and a media space palette having a media space representing an output device, where a third icon representing a window is generated by applying the first icon to the media space palette based on a system where a user has encrypted characteristics of the media source in the first icon and characteristics of the output window and/or output device in the media space, and where the system is configured for the user to operate the media facility by selecting the first icon and applying it to the media space palette to provide that an output of the media source is coupled to an input of the output device through the integration system.

In another embodiment, the invention relates to an integration system suitable for configuring a media facility, said integration system including a display device suitable for displaying at least one first icon representing a media source, a window processing system, and at least one media space representing an output window of an output device, an input device suitable for selecting said at least one first icon and applying it to said at least one media space, the input device being configured for a user to encrypt characteristics of the media source and the generated window in said at least one first icon, and to encrypt characteristics of the output device in said at least one media space, and a storage device suitable for storing a configuration for providing an output of the media source to an input of the output window through the integration system.

In another embodiment, the invention relates to a method of configuring a media facility having at least one media source, an output device having one or more output windows, and a media integration system having a media space icon, the method comprising: generating a first icon representing the at least one media source, the at least one media source having an output configured to be coupled to an input of the output device through the media integration system, encrypting characteristics of said at least one media source in the first icon, selecting the first icon, applying the selected first icon to the media space icon to provide the output of the at least one media source to the input of the output device through the media integration system, generating a window icon on the media space icon, the window icon representing one of the one or more output windows, encrypting characteristics of the output window and/or the output device in the window icon, and displaying the first icon and the window icon on a display device.

In another embodiment, the invention relates to a media management system suitable for configuring a media facility, said system comprising: a media source, an output device having one or more output windows, and an integration system coupled to the media source and the output device, said integration system comprising a display device configured to display a first icon representing the media source and a media space icon having a window icon representing an output window, where the system is configured for a user to encrypt characteristics of the media source in the first icon and characteristics of the output window and/or output device in the window icon, and where the system is configured for the user to operate the media facility by selecting the first icon and applying it to the media space icon to provide that an output of the media source is coupled to an input of the output device through the integration system.

In another embodiment, the invention relates to an integration system suitable for configuring a media facility, said integration system comprising: a display device suitable for displaying at least one first icon representing a media source and at least one window icon representing an output window of an output device, an input device suitable for selecting said at least one first icon and applying it to said at least one window icon, the input device being configured to encrypt characteristics of the media source in said at least one first icon and to encrypt characteristics of the output window and/or output device in said at least one window icon, and a storage device suitable for storing a configuration for providing an output of the media source to an input of the output window through the integration system.

### BRIEF DESCRIPTION OF THE DRAWINGS

These and other aspects of the invention can be understood by reference to the following detailed description, taken in conjunction with the accompanying drawings, which are briefly described below.

FIG. 1 is a system diagram of a media management system in an exemplary embodiment according to the present invention;

FIG. 2 is a flow diagram of a process of encrypting and displaying a source icon and a media space;

FIG. 3 is a flow diagram of a process of configuring media sources and output devices, and storing and recalling the configuration;

FIG. 4 is a system diagram of a media management facility;

FIG. 5 is a screen shot of the main control screen for a media integration system;

FIG. 6 is a schematic system diagram of a media management system in an embodiment according to the present invention;

FIG. 7 is a schematic screen shot of the display device of FIG. 6 in an embodiment according to the present invention;

FIG. 8 is a flow diagram of a process for initializing a media management system in an embodiment according to the present invention; and

FIG. 9 is a flow diagram of a process for operating a media management system in an embodiment according to the present invention.

### DETAILED DESCRIPTION

An integration system in an exemplary embodiment according to the present invention, which may be referred to herein as the Integrator PixelBlaster™, simplifies the scripting and the management of these complex media facilities. The concept is based around intelligent icons.

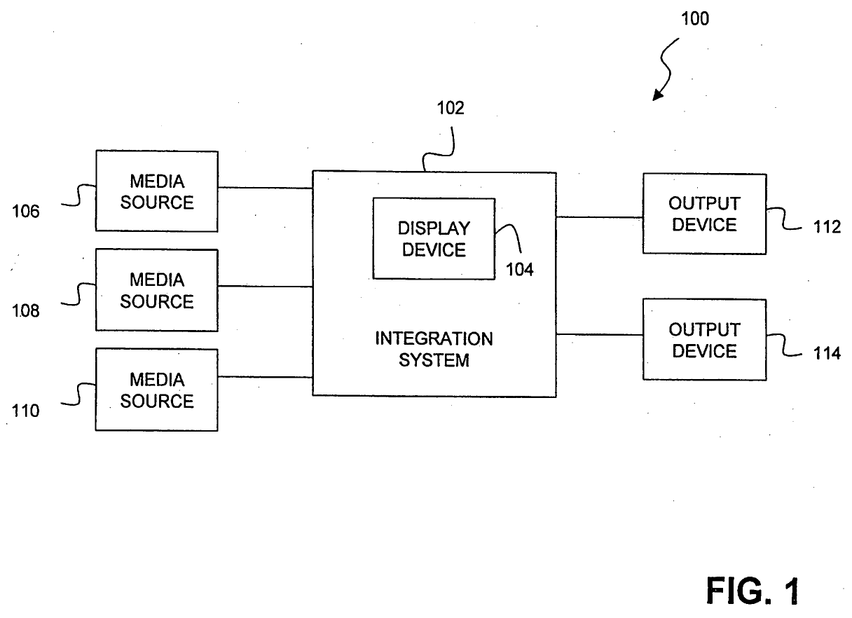

FIG. 1 is a system diagram of a media management system (which may also be referred to as a media control system) 100 in an exemplary embodiment according to the present invention. The media management system 100 includes an integration system 102, which is capable of coupling a plurality of media sources 106, 108 and 110 to a plurality of output devices 112 and 114. The integration system 102 includes a display device 104 for displaying (or presenting), for example, icons that represent media sources and output devices. The integration system 102 may also include one or more matrix switchers for coupling the media sources to the output devices and/or one or more image processors (e.g., picture-in-picture processor, edge blender, image scaler, image warper, etc.).

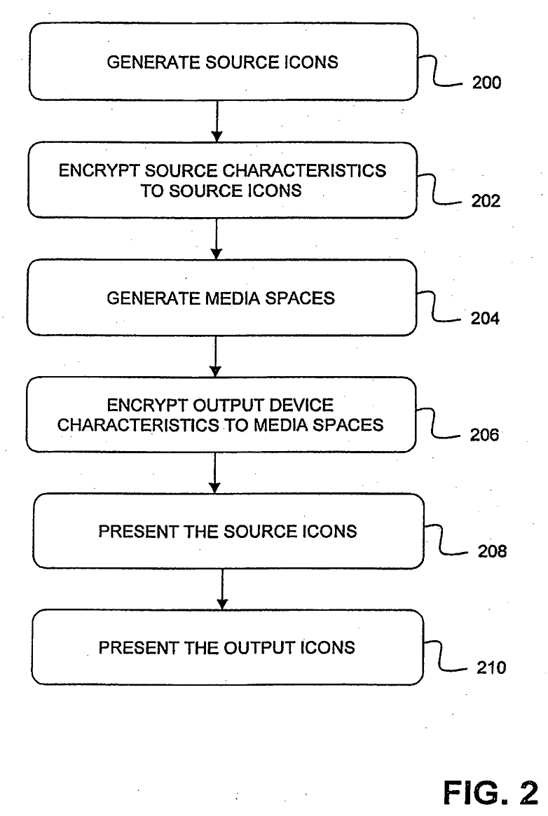

The icons that represent the media sources 106, 108 and 110 should be intelligent source icons. The source icons, generated in step 200 of FIG. 2, in the exemplary embodiment have encrypted in them source characteristics as indicated in step 202. The source characteristics may include, for example, the nature of the source's output signals, the number of channels of the source, frequency of operation, frame rate, location of plugging into a matrix switcher, its associated audio source, location of plugging of the associated audio source into the matrix switcher, normal volume settings for the audio, signal processing recalls used for that source, and other related information.

The icons that represent the output devices 112 and 114 should also be intelligent output icons. These output icons may also be referred to as media spaces, display icons or screen icons. The output icons, generated in step 204 of FIG. 2, in the exemplary embodiment have encrypted in them output characteristics as indicated in step 206 of FIG. 2. The output characteristics for the output devices 112 and 114 may include, for example, plugging locations into the matrix switcher outputs, normal preset selections for specific input signal characteristics, location of audio system outputs for a particular device, projector settings, and other related information.

As indicated in steps 208 and 210 of FIG. 2, respectively, the source and output icons are displayed (or presented) on the display device 104. With all these characteristics defined as part of the intelligent icons, it is possible to drag and drop a source icon onto an output icon and the integration system 102 knows exactly the scripting sequence required to present that source on that output device. The output icons (or media spaces) may be a graphical representation of the display device or the entire facility itself. For example, an output icon corresponding to a three monitor system may actually include graphics depicting three monitors. Therefore, on the display device of the integration system, media spaces may look similar to the layout of the physical system itself, graphical representation of display screens, and/or sound systems.

As discussed earlier, characteristics encrypted in the source icons and the media spaces are not just for external control, but they may be for controlling all the devices in the signal path. Hence, when a source icon is dragged and dropped onto a media display space, not only the media source and the target display device are configured, but all the devices in the signal path between them are configured as well. In order to support configuration of devices in the signal path, the characteristics of these devices may also be encrypted in the source icon and/or the media space.

The components of the system in the signal path may include one or more of, but not limited to, matrix switchers, image processors, projectors, audio systems, etc. Image processors may include a picture-in-picture processor, an edge blender, an image scaler, an image warper, etc.

In the case of a picture-in-picture processor or window processor, the source icon encrypted characteristics may be associated with a third window icon which is placed inside a media space icon and may itself then contain further encrypted characteristics including size, placement, border, scaling and cropping characteristics.

Further, the configuration of the system components in the signal path may include, for example, display configurations, audio configuration, projector configurations and switcher configurations. In the exemplary embodiments, the configuration of the system components are also realized through encrypting all the characteristics in the source icons, window icons and media spaces. In a sense, the exemplary embodiment provides a user programming method, through which a user of a media management system is empowered to flexibly program a media management system via a GUI (graphical user interface).

Therefore, exemplary embodiments according to the present invention provide for a user to essentially program the facility himself or herself. The underlying software may be written by the system/software vendor, however, it is the user that actually configures the facility to meet his or her needs. This way, the users are empowered to manage complex systems themselves. Using conventional systems, users have typically relied on pre-programmed solutions. The GUI of the present invention has empowered the user to do a great deal of programming without having to deal with actual complexities of coding and setting component configurations.

In other embodiments, a configuration module is provided, which a user has access to, and with which a user can configure a new source and create a new source icon for it. Further, the user has an ability to encrypt the characteristics of the new source in the source icon.

The integration system may be used in a standardized facility setting so that the users are capable of easily memorizing where devices or components of the system are located. In other embodiments, tool kits may be provided to the user so that the user may be able to build his or her own graphics representation of the facility to be displayed in accordance with the facility setting that the user has configured.

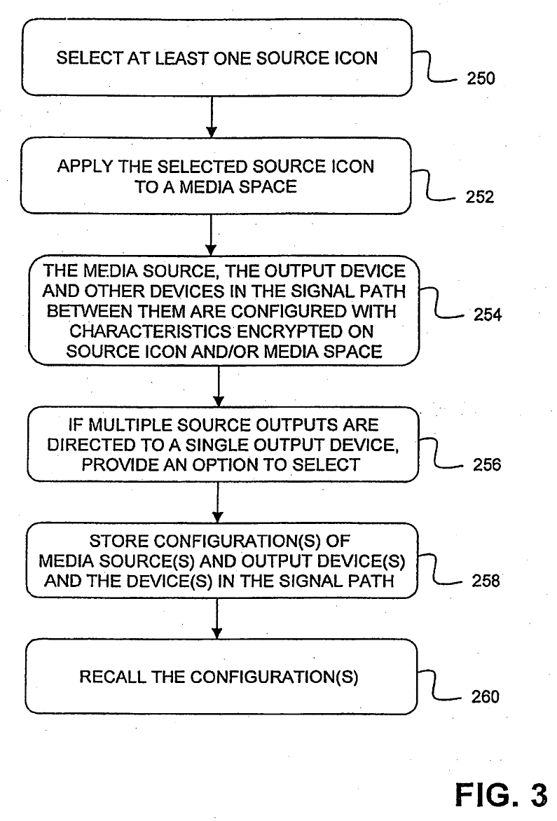

In steps 250 and 252 of FIG. 3, at least one source icon is selected and applied to an output icon. In step 254, the media source, the output device and other devices in the signal path between them are configured with characteristics encrypted on the source icon and/or the media space.

In another embodiment for step 254, the characteristics encrypted in the source icon will generate a third window icon based on those characteristics. In a step subsequent to step 254, the user can then further specify and encrypt additional characteristics of the window icon including location, size, scale, border, titling, etcetera, which are then saved and stored.

In one embodiment, if a multi-channel graphics computer source icon is dragged (selected and applied) onto the output icon for a multi-channel, edge blended display—the integration system's intelligence automatically knows to route the correct source signal to the correct output, select the correct projector recall for that signal, select the normally associated audio for that source and route it to the display audio system, route the correct source channel to the control monitor, and select the correct recall setting for any signal processing device such as, for example, edge blending or signal compatibility processors.

In another embodiment, if a source icon is dragged (selected and applied) onto a media space icon, then the integration system's intelligence is configured to open a window on the output device for that media source and to place a window icon on the media space icon where the window icon represents that source. The user can then move the window icon to different areas of the media space icon resulting in corresponding movement of the window on the output device. This also can apply to sizing and scaling of the window icon resulting in the sizing and scaling of the window in the output device.

All the user has done in this case is to drag the source icon onto the output icon and the result is that the source appears on the screen that it has been dragged onto-all formatted correctly. If it is a window, he can then place, size and scale the window to the desired result.

In certain cases, however, a source icon may designate a source as multiple source outputs, which may have been directed to a single output device or window as indicated in step 256 of FIG. 3. In such cases, a user should be provided with an option to select one of the multiple source outputs as also indicated in step 256. For example, a two channel multi-channel source icon may be dropped onto a single screen control monitor icon. In this case, the system intelligence says—there are two possible outputs that the user may want to present on this single control monitor, a set of selection buttons should be added below the monitor to allow the user to select which of the two channels to view.

If a single channel source icon were to be dropped onto the same control monitor icon, it would not require the selection buttons and therefore they would not appear.

All these intelligent attributes put the control of the media environment back to the user's hands instead of sequence programmers who must otherwise program presets.

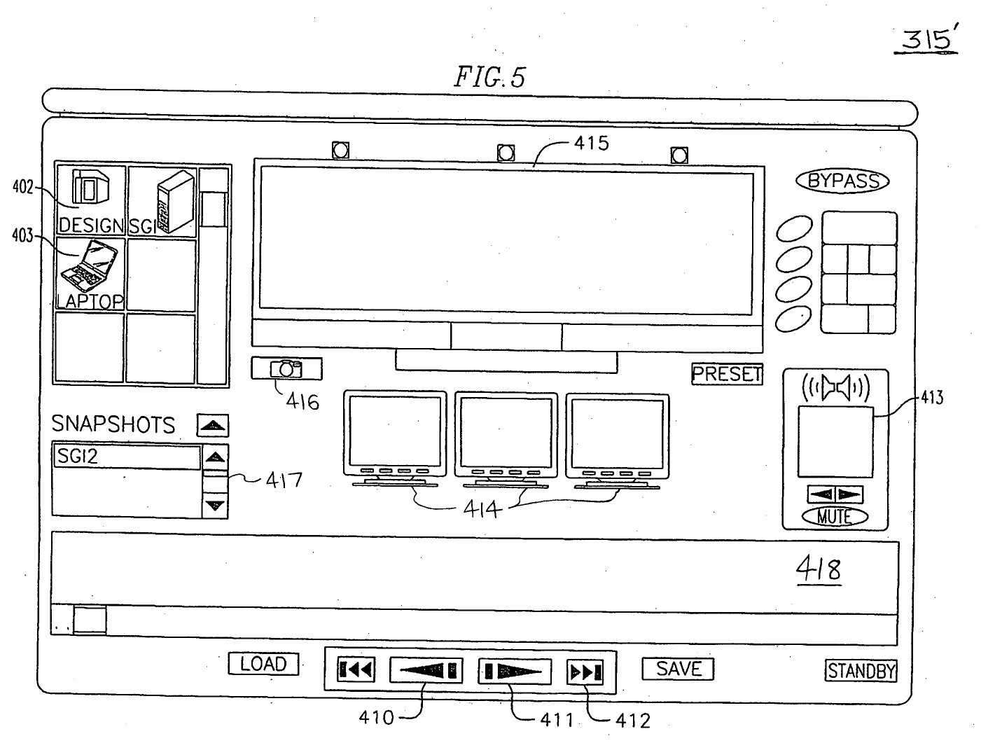

This is carried further—particularly in complex environments where the user may have dropped various sources onto various displays or various windows within various displays—they each appear and behave on the associated display as expected—but the entire room configuration may take a number of drag and drop actions. Once the entire media room is configured exactly as the user wants it, with various sources formatted to the various outputs and/or various windows laid out in desired configurations with window attributes in the manner that the user wants, then the user can click on a snapshot button such as 416 in FIG. 5, which captures the configuration variables and saves them under a snapshot name such as 417 in FIG. 5. Thus, as indicated in step 258 of FIG. 3, one or more configurations of media source(s), output device(s) and the device(s) in the signal path between them may be stored. Further, as indicated in step 260, the configurations can be recalled. In essence the entire configuration is saved and can then be quickly re-invoked by selecting the appropriate snapshot. When a number of configurations are stored in a single snap shot, the resulting configuration may be referred to as a combination configuration.

Furthermore, once the user has created a set of named snapshots, they may wish to sequence those snapshots into an order that is suitable for a presentation or another reason requiring a sequence of presets.

For this the snapshots can be dragged into a sequencer window such as 418 in FIG. 5, which allows the step by step access to the snapshot configurations in the order they have been laid out. New or same snapshots may repeat as needed.

This sequence can then be stepped forward or backward manually using buttons such as 410, 411 and 412 in FIG. 5, random selected, or stepped based on time of day, a pre-timed sequence or selected based on any variety of external conditions.

Alternately, the user may wish to make these snapshots easily accessible in a random fashion. In one embodiment, this can be achieved by assigning the snapshots to function keys on a typical keyboard. By pressing a function key, the entire recall sequence can be invoked.

Alternately, the user may wish to make these snapshots easily accessible via a traditional facility control system such as the aforementioned AMX or Crestron systems. For this, the snapshots can be recalled by having the traditional facility control system send a simple coded message to the media management system over a network causing the media management system to recall the sequence.

Alternately, the user may wish to utilize another monitoring system which under certain circumstances, such as the detection of an emergency condition, sends a simple coded message to the media management system over a network causing the media management system to recall a sequence that is related to that emergency condition.

Thus the combination of intelligent source icons, intelligent output icons, intelligent window icons, snapshots, sequencer, external controllers, conditional monitoring systems and any sub-combination thereof, provides a new type of media management control that is unique and intuitive and easy for the user to operate.

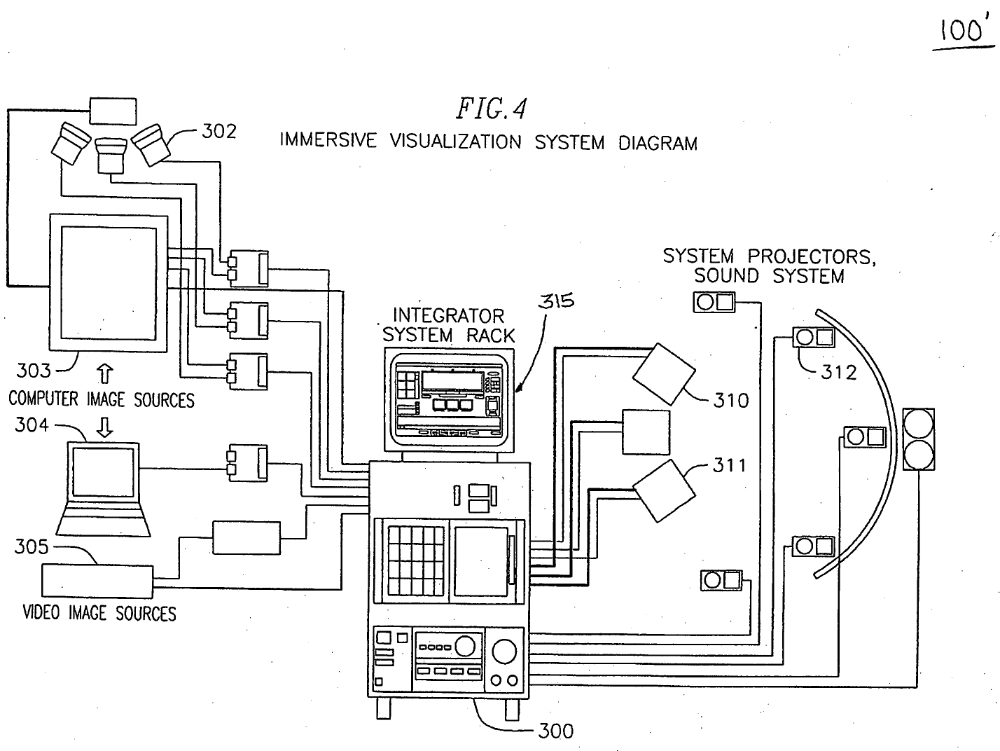

FIG. 4 is a system diagram of a media management facility 100′ in one exemplary embodiment. The media management facility 100′ includes media sources 302, 303, 304, and 305, a media integration system 300, and output devices 310, 311, and 312. The media integration system 300 is coupled to media sources 302, 303, 304, and 305 and output devices 310, 311, and 312. The media integration system 300 includes a display device 315.

The media sources 302 can be multiple video cameras or other video sources. The media sources 303 and 304 can be computer image sources such as personal computers, workstations, laptops, or other computing devices. The media source 305 can be a video image source such as a VCR (video cassette recorder), DVD (digital video disc) player, or any other suitable video image source. The output devices can be televisions, monitors, video projectors, flat panels, control monitors, audio systems, LCDS, PDPS, Sony SXRD (silicon x-tal reflective display) devices, OLEDs (or organic light emitting diode) HDTV (high definition television) devices or any other video display device. In operation, the media integration system 300 can function as described previously in the discussions of FIG. 2 and FIG. 3.

FIG. 5 is a screen shot of the main control screen of a media integration system in one exemplary embodiment. Source library icons 402, 403 represent media sources. Output control icons, namely, a projector control screen object or media space palette 415 and an audio control icon 413, and preview or auxiliary monitors 414 represent output devices. In the described embodiment, the projector control screen object 415 represents the screen on which images are projected. By clicking, dragging, and releasing the source library icons onto the projector control screen object 415, users can program what they want to see and where they want to see it. A snapshot icon 416 is used to store a complete facility configuration. Multiple snapshots can then be represented in the snapshot palette 417. Snapshots can be dragged into the sequencer palate, 418 and sequencer control buttons 410, 411 and 412 allow the users to display snapshots in order.

In operation, a user can select a source icon and move it to a media space, audio, preview and/or auxiliary palette in a manner similar to the methods described previously in the discussions of FIG. 2 and FIG. 3.

In most common cases and historically, there has been a “one-for-one” relationship between sources and displays. With N sources there might typically be N displays. At some point, adding more displays becomes impractical making it necessary for multiple sources to share the same display.

Now there is yet another factor to consider. With the introduction of extreme resolution display technologies such as the Sony 4K SXRD projection system, which provide 4096×2160 pixels of resolution and which represent a jump of four orders of magnitude in resolution over HDTV, the one-to-one paradigm of sources to display becomes inverted. Now a single display system can carry the standard resolution of many sources. This means that now, organizing sources into windows on a single display system can become a similar but very distinct challenge.

Note that this is specifically different from opening many windows for documents and programs on a single computer. In that paradigm, the computer operating system is managing the windows and their characteristics. In this paradigm, we might want to integrate the graphics output of many sources including computers into a common space using a separate window creation system, which may also be a computer with input capture boards and that is part of the media control system.

Bringing a media source into a multi-window display may comprise a sequence such as:

1. Find where in the system the media source is plugged in;

2. Route that media source to the window processor;

3. Open a window for the source in the output display;

4. Place the window into a desired location relative to any other windows in the output display;

5. Size and/or scale the content of the window and the window itself in the output display;

6. Assign a keyboard and mouse control port to that source if that source is a computer;

7. Manage the attributes of that window as desired including border, border size, color, titles, font, font size, font color, internal crops, internal pan/scan, etcetera;

8. Route the audio from the source to the main sound system; and

9. Set the volume control of the audio to the proper level.

With the relationship of more than one source to one output device, the display becomes one mega resolution display showing an organized array of many windows filled with many sources, where the media control system can be used to route and configure the media components to the proper windows and layout within the high resolution projected image.

Electronic technologies exist that are capable of performing such windowing tasks, but again, they have mostly been developed with a one source to one input relationship. With systems that have large amounts of sources, an upstream switcher might also need to be controlled. Additionally, a number of other factors including image processors and attributes might also need to be addressed. Most windowing systems were developed for multi-display devices such as cube walls or multi-projector arrays.

One embodiment could address a number of other attributes that extend beyond the processor control including complex switcher and routing information; graphical output characteristics of each source; channel (multi-channel or single) attributes; I/O (input/output) switching so that the windowed source, once selected, can be controlled by a master keyboard and mouse; audio attributes including stereo, mono or surround sound attributes or three dimensional (3D) stereoscopic attributes for 3D displays or windows and other appropriate attributes.

To the user, operation can be as simple as dragging a source icon onto a screen space and having this action open a window for that source with all its attributes engaged.

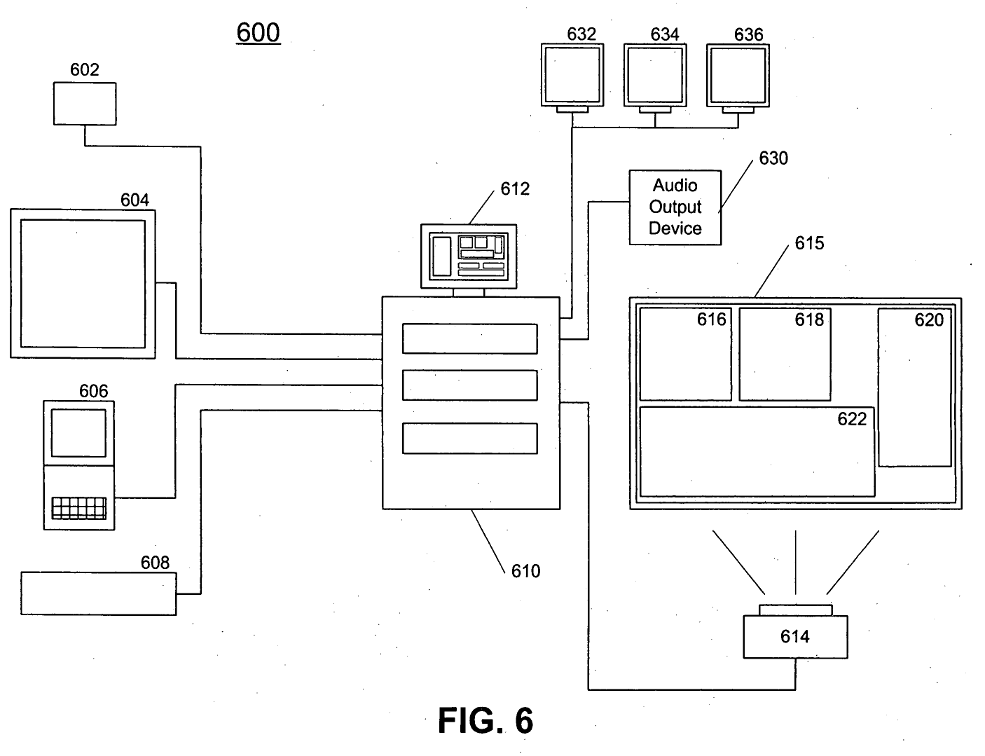

FIG. 6 is a schematic system diagram of a media management system in an embodiment according to the present invention. The media management system 600 includes media sources 602, 604, 606, and 608, a media integration system 610 which includes a window processing module (not shown), and output devices 614, 630, 632, 634 and 636. The output device 614 is a video/graphics output device for displaying an image or images, whereas the output device 630 is an audio output device including one or more speakers. By way of example, the speakers may be arranged in a configuration to provide a surround sound effect. Output devices 632, 634 and 636 are video/graphics output devices that can include audio outputs. In some embodiments, the audio and video/graphics output devices may be included in a single integrated device (e.g., projector). The media integration system 610 includes a display device 612.

The output device 614 depicted in FIG. 6 is a projector that projects an image or images to a screen (or display screen) 615. In the described embodiment, the projected image includes output windows 616, 618, 620 and 622 that appear on the screen 615. A window can be thought of as a visual area, usually rectangular in shape, that is capable of displaying the output of a media source and having various characteristics of the media source and/or output device encrypted with it. In one embodiment, media sources 602, 604, 606 and 608 can be represented by windows 616, 618, 620 and 622.

The media integration system is connected to media sources 602, 604, 606 and 608, and output devices 614, 630, 632, 634 and 636. In one embodiment, the output device 614 and the screen 615 are combined into a single unit (e.g., a flat panel display device).

In one embodiment, the media source 602 can be a cable television source or video camera source. In some embodiments, there can be more than one media source 602 for providing television or video camera input. In one embodiment, media source 604 can be a personal computer, workstation, game console or other computing device. In one embodiment, media source 606 can be a laptop or other video source. Media source 608 can be a VCR, DVD player, compressed audio player, compressed video player, or other video or audio source. In many embodiments, any number and variety of media sources 602, 604, 606, and 608 can be connected to the media integration system.

In an exemplary embodiment, the output device 614 can support high video resolutions and is capable of displaying multiple windows using the high resolution output of the display. In one embodiment, the output device 614 can be a television, a monitor, a video projector, a flat panel display device, a control monitor, an audio system, LCD, PDP, Sony SXRD® device, organic light emitting diode (OLED) display device, HDTV device or any other suitable video display device. SXRD® is a registered trademark of Sony Corp., Tokyo, Japan. In one embodiment, the output device 614 can have a resolution of 4096 by 2160 pixels or any other suitable resolution or number of pixels. In exemplary embodiments, the screen 615 can have a size suitable for displaying a high video resolution or a number of output windows having various sizes and/or resolutions.

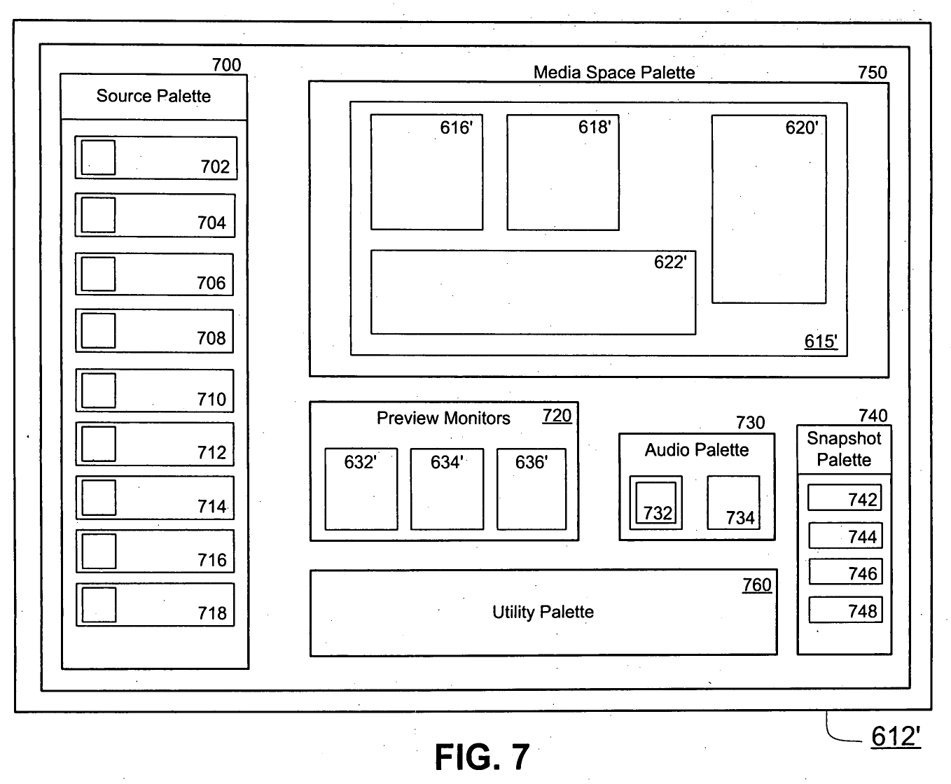

FIG. 7 is a schematic screen shot 612′ of the display device 612 of FIG. 6 in an embodiment according to the present invention. The screen shot 612′ includes a source palette (or window) 700, a media space icon (or window) 750, a preview monitor palette (or window) 720, an audio palette (or window) 730, a snapshot palette (or window) 740, and a utility palette (or window) 760. The source palette 700 includes media source icons 702, 704, 706, 708, 710, 712, 714, 716, and 718. The media source icons 702 to 718 can represent a variety of audio and/or video sources. In some embodiments, a media source icon can represent a source associated with both audio and video such as a VCR.

The media space palette (or window) 750 includes a media space icon 615′ which is used to display window icons 616′, 618′, 620′ and 622′ that correspond respectively with the output windows 616, 618, 620 and 622. In one embodiment, the window icons are separately generated and encrypted (or encoded) by the user with certain characteristics (e.g., size or location) corresponding to the characteristics of the output windows on the screen 615 (or any other suitable display area). In other embodiments, the window icons are generated (e.g., automatically generated) by the media management system 600 when one or more media source icons in the source palette (or window) 700 are applied (e.g., dragged and dropped using a mouse) to the media space icon (or window) 615′. In another embodiment, the window icons are generated (e.g., automatically generated) by the media management system when the user or system recalls a stored configuration (i.e. snapshot) of window icons on a media space icon.

In one embodiment, the media space palette 750 has one media space icon 615′ representing the screen 615 of an output device 614. In other embodiments, the media space palette 750 can have multiple media space icons representing multiple output devices and/or screens of output devices.

In many embodiments, the user is able to change the location and/or size of window icons 616′, 618′, 620′ and 622′, thereby resulting in changes to the size and location of the output windows 616, 618, 620 and 622 with respect to each other, and also with respect to the overall display of the image on the screen 615. In other embodiments, one or more of the window icons (and therefore the output windows) can be overlapped with respect to one or more other window icons (and therefore the output windows). Such overlapped window icons (and the output windows) may be opaque such that a window or a portion thereof may not be visible when another window or a portion thereof is overlaid on top of it. In other embodiments, the overlapping or superimposed portions may be transparent and/or blended together (e.g., using alpha blending, for example). In other embodiments, the overlapping or superimposed portions may be assigned a layer designation so that they are superimposed on certain windows while other windows may be superimposed on them.

The preview monitor window 720 includes preview media spaces 632′, 634′, and 636′. The audio palette (or window) 730 includes audio media spaces 732 and 734. The snapshot palette (or window) 740 includes snapshot icons 742, 744, 746 and 748. The snapshot icons are used to represent different configurations (i.e., snapshots) of mapping between the media sources and the output windows/devices, and can be applied in sequence such that outputs of the media sources can be displayed on different output windows on the screen 615 sequentially. Further, each snapshot can include the information on the audio device (or channel) selected to provide audio output to the audio output device 630.

In one embodiment, the source palette (or window) 700 can include more than or less than the nine media source icons depicted. In one embodiment, the media space icon (or window) 615′ can include more than or less than the four window icons depicted. In one embodiment, the preview monitor window 720 can include more than or less than the three preview media spaces depicted. In one embodiment, the audio palette (or window) 730 can include more than or less than the two audio sources depicted. In one embodiment, the snapshot palette (or window) 740 can include more than or less than four snapshot icons. In one embodiment, the window icons can represent an array of auxiliary independent output media devices such as LCD or plasma display devices, computer display panels, other audio systems and more.

The source palette (or window) 700 can include icons 702-718 representing the media sources that are coupled to the media integration system 610. The media space icon (or window) 615′ can include one or more window icons (e.g., 616′, 618′, 620′ and 622′) that correspond to output windows on the output devices (or the projection screen when the output device is a projector) coupled to the media integration system 610. The preview monitor palette (or window) 720 can be used to view a media source before applying the source icon to a window icon in the media space icon (or window). In operation, a source icon can be applied to a preview media space. For example, source icon 702 could be applied to preview media space 632′. In response, output device 632 of FIG. 6 would display the source video and/or audio corresponding to source icon 702. Thus, preview media space 632′ can correspond to output device 632. In the same way, preview media spaces 634′ and 636′ can correspond to output devices 634 and 636, respectively.

In one embodiment, the selection of a media space or window icon would enable the media source associated with the window icon to be controlled by a master keyboard and mouse connected to the media integration system. Selection of a different media space or window icon would cause the source associated with the different media space or window icon to be the recipient of I/O information from the master keyboard and mouse.

The audio palette (or window) 730 can be used to apply audio sources corresponding to the audio media spaces 732 and 734 to the audio output device 630. In operation, when the source icon is dragged to the audio media space 732, that audio source is routed to the audio output device 630. In one embodiment, the audio source can be added to a media space already associated with a media source such that the video is provided by the media source and the audio is provided by the audio source.

The snapshot palette (or window) 740 can be used to capture one or more snapshots 742, 744, 746, 748 and 750 of configurations of media sources applied to media spaces. A snapshot can be a configuration of media spaces and/or window icons, including the sizes, shapes or other characteristics. In one embodiment, the snapshot can include the media source characteristics encrypted in the media spaces or window icons. The snapshot can be recalled upon demand by the user.

The utility palette (or window) 760 can include a number of use functions such as media space controls or window icon controls. In one embodiment, the utility palette (or window) 760 can be used to modify the size, placement, shape, border and labeling of a media space or window icon window. In another embodiment, the media space controls can stop, record, take a snapshot of, and/or replay a media source. In one embodiment, the utility palette (or window) 760 can be customized for various video or audio functions.

The window icon 616′ represents a selected media source being played or displayed on the screen 615 of the output device 614. The video being played on output window 616 of the screen 615 of the output device 614 is from one of the source icons such as 702, 704, 706, 708, 710, 712, 714, 716 and 718 (e.g., video source) and corresponds to the window icon 616′. In the same way, the window icon 618′ corresponds to the output window 618, the window icon 620′ corresponds to the output window 620, and the window icon 622′ corresponds to the output window 622. In several embodiments, the audio output device 630 can play the audio portion of the selected media source. In many embodiments, the number of window icons or output windows can be more than or less than four.

In an exemplary embodiment, the sizes and shapes of the window icons (and corresponding output windows) can be controlled by the user. In one embodiment, user control can be achieved using the utility palette (or window) 760. In an exemplary embodiment, the sizes and shapes of the output windows correspond to the sizes and shapes of their respective window icons. In this way, the output windows are not limited to a fixed location or size. Output windows can be changed to support the characteristics of a particular media source. The size and shape of an output window are characteristics that can be encrypted (or encoded) to an window icon and saved in a snapshot.

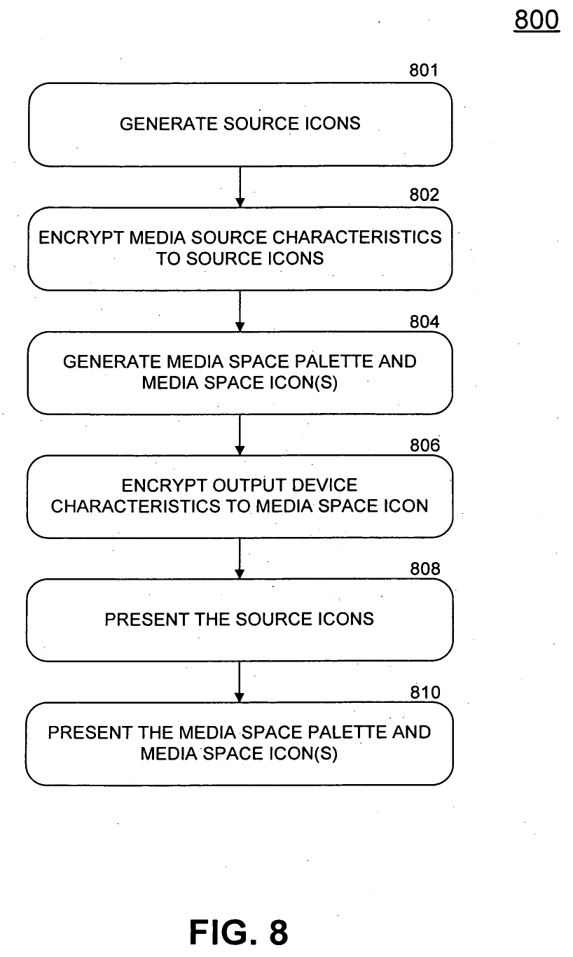

FIG. 8 is a flow diagram of a process for initializing a media management system in an embodiment according to the present invention. In the initialization process 800, the media integration system 610 (shown in FIG. 6) of the media management system generates (801) source icons (or media source icons) corresponding to the available media sources coupled to the media integration system 610. The media integration system 610 then encrypts (802) the media source characteristics to the source icons.

The media integration system 610 then generates (804) the media space palette and media space icons (and/or media spaces and or window icons) corresponding to the output devices (and/or output windows on the screen of the output devices according to a stored snapshot). The media integration system 610 then encrypts (806) the output device characteristics to the media space icon (and/or window icons). In many embodiments, the output device characteristics include the characteristics of the output device displaying the output windows or the screen of the output device. The media integration system 610 then presents (808) the source icons (or media source icons) on the display device. The media integration system 610 then presents (810) the media space palette and media space icon(s) on the display device. In one embodiment, window icons are presented on the media space icon (or window) according to a stored configuration.

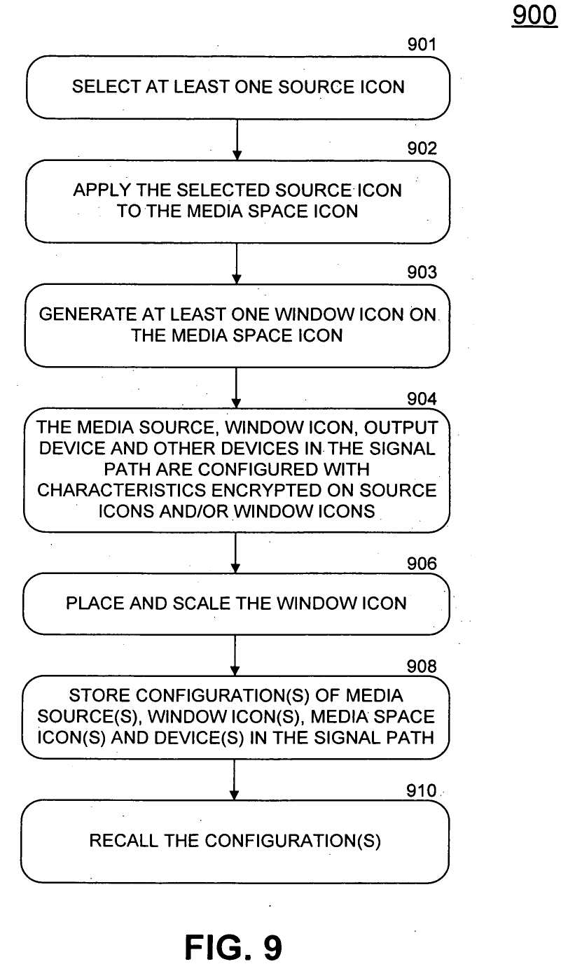

Once the multimedia system has been initialized, a user can operate the system. FIG. 9 is a flow diagram of a process for operating a media management system in an embodiment according to the present invention. In the operation process 900, the user of the system selects (901) at least one source icon (or media source icon) from the source palette (or window) 700. The user of the system then applies (902) the selected source icon to the media space icon 615′ (or to one of the window icons). The media integration system 610 then generates (903) at least one window icon in the media space icon (or window), in response to the user's action.

The media integration system 610 then configures (904) the selected media source, the window icon, the output device and other devices in the signal path with characteristics encrypted to the source icon and/or window icon. The signal path can be the path between the window icon and the output window. The signal path can include complex source switching devices, image processing systems including window processors, the output device and/or a projection path between the output device and the display screen. The window icons are then placed (906), sized, scaled, and positioned as desired. The media integration system 610 then stores (908) the configurations (e.g., snapshots) of media sources, window icons, media space icon (or window) and any devices in the signal path. In many embodiments, the configuration of the media space icon (or window) and/or window icons includes the size and placement of the media space icon (or window) and window icons along with the source icons and the characteristics having been associated with the source icons. The integration system then recalls (910) the configurations.

There are a number of ways of generating the at least one window icon on the media space icon. In one embodiment, the at least one window icon is generated by the media integration system in response to the user applying a source icon to the media space icon. In another embodiment, a default configuration (i.e. a snapshot) is recalled and the media integration system generates the at least one window icon according to the default configuration. In yet another embodiment, a user specified configuration (i.e. a snapshot) is recalled and the media integration system generates the at least one window icon according to the user specified configuration. In one embodiment, the associations of source icons to window icons are also stored in a snapshot and can be recalled. In one embodiment, the user recalls a specified configuration (i.e. a snapshot) using a traditional control system such as the aforementioned AMX or Crestron systems. In one embodiment, an automated monitoring system recalls a specified configuration (i.e. a snapshot) based on pre-defined conditions that are being monitored such as an automated response to an emergency condition.

In one embodiment, a user can operate the media management system by:

generating a first icon representing the at least one media source, the at least one media source having an output configured to be coupled to an input of the output device having an output window through the media integration system;

encrypting characteristics of said at least one media source by a user in the first icon;

generating a window icon representing an output window of the output device;

encrypting characteristics of the output window in the window icon;

displaying the first icon and window icon on a display device;

selecting the first icon; and

applying the selected first icon to the window icon to provide the output of the at least one media source to the input of the output device through the media integration system.

In another embodiment, a user can further operate the media management system by:

a) generating a plurality of second icons, each second icon representing one of a plurality of media sources;

b) encrypting characteristics of one of the media sources to the second icon that represents it;

c) generating a plurality of second window icons, each window icon representing one of a plurality of output windows;

d) encrypting characteristics of one of the output windows and/or output device to the second window icon that represents it;

e) displaying the second icon and second window icons on a display device;

f) selecting one of the second icons;

g) applying the selected one of the second icons to one of the window icon; and

h) repeating f) and g) until a desired combination configuration is realized, in which all desired second icons have been selected and applied to the second window icons.

In one embodiment, media spaces, audio media spaces, preview media spaces and any other media spaces can be used and configured just like window icons. In that case, the embodiments of FIGS. 8 and 9 would treat any media space as a window icon.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims and their equivalents rather than the foregoing description.

What is claimed is:

1. A method of configuring a media facility having at least one media source, an output device having one or more output windows, and a media integration system having a media space icon, the method comprising:
generating a first icon representing the at least one media source, the at least one media source having an output configured to be coupled to an input of the output device through the media integration system;
encrypting characteristics of said at least one media source in the first icon;
selecting the first icon;
applying the selected first icon to the media space icon to provide the output of the at least one media source to the input of the output device through the media integration system;
generating a window icon on the media space icon, the window icon representing one of the one or more output windows;
encrypting characteristics of the output window and/or the output device in the window icon; and
displaying the first icon and the window icon on a display device.

2. The method according to claim 1, further comprising encrypting characteristics of a system component in a signal path between the at least one window icon and the output device in at least one of the first icon and the window icon.

3. The method according to claim 1, further comprising presenting the video from the at least one media source on the window icon.

4. The method according to claim 3, further comprising presenting the video from the at least one media source on at least one of the one of more output windows.

5. The method of claim 1, wherein said at least one media source comprises at least one selected from a group consisting of video and audio sources.

6. The method of claim 5, wherein the video source comprises at least one selected from a group consisting of a computer, a VCR, a cable feed, a satellite feed, a DVD player, a video server, a video camera, a compressed audio, a compressed video player, a sensor and a television.

7. The method of claim 5, wherein the audio source comprises at least one selected from a group consisting of a computer, a VCR, a cable feed, a satellite feed, a DVD player, an audio server, a compressed audio player, a compressed video player, a microphone, a cassette player and a radio.

8. The method of claim 1, wherein selecting comprises dragging the first icon, and applying comprises dropping the first icon onto the media space icon.

9. The method of claim 1, wherein the output device comprises at least one selected from a group consisting of a video projector, a monitor, a flat panel, an audio system, a television, an LCD (liquid crystal display), a PDP (plasma display panel) and a Sony SXRD device.

10. The method of claim 1, further comprising:
a) generating a plurality of second icons, each second icon representing one of a plurality of media sources;
b) encrypting characteristics of one of the media sources to the second icon that represents the same media source;
c) generating a plurality of second window icons, each second window icon representing one of a plurality of output windows;
d) encrypting characteristics of one of the output windows and/or the output device to the second window icon that represents the same output window;
e) displaying the second icon and second window icons on a display device;
f) selecting one of the second icons;
g) applying the selected one of the second icons to one of the second window icons; and
h) repeating f) and g) until a desired combination configuration is realized, in which all desired second icons have been selected and applied to the second window icons.

11. The method of claim 10, further comprising storing the desired combination configuration.

12. The method of claim 11, further comprising recalling the stored desired combination configuration.

13. The method of claim 10, further comprising repeating a)-g) to realize a plurality of desired combination configurations and storing the desired combination configurations.

14. The method of claim 13, further comprising recalling said desired combination configurations in a sequence.

15. The method of claim 10, further comprising encrypting characteristics of system components in a signal path between said media sources and the output device onto at least one of the second icons and second window icons.

16. A media management system suitable for configuring a media facility, said system comprising:
a media source;
an output device having one or more output windows; and
an integration system coupled to the media source and the output device, said integration system comprising a display device configured to display a first icon representing the media source and a media space icon having a window icon representing an output window,
wherein the system is configured for a user to encrypt characteristics of the media source in the first icon and characteristics of the output window and/or output device in the window icon, and
wherein the system is configured for the user to operate the media facility by selecting the first icon and applying it to the media space icon to provide that an output of the media source is coupled to an input of the output device through the integration system.

17. The media management system of claim 16, further comprising at least one device in a signal path between the media source and the output device,
wherein the system is configured for the user to encrypt characteristics of said at least one device in at least one of the first icon and/or window icon.

18. The media management system of claim 16, wherein said the media source comprises at least one selected from a group consisting of video and audio sources.

19. The media management system of claim 18, wherein the video source comprises at least one selected from a group consisting of a computer, a VCR, a cable feed, a satellite feed, a DVD player, a video server, a video camera, a compressed audio player, a compressed video player, a sensor and a television.

20. The media management system of claim 18, wherein the audio source comprises at least one selected from a group consisting of a computer, a VCR, a cable feed, a satellite feed, a DVD player, an audio server, a compressed audio player, a compressed video player, a microphone, a cassette player and a radio.

21. The media management system of claim 16, wherein the system is configured for the user to select the first icon and apply it to the media space icon by dragging the first icon and dropping it onto the media space icon.

22. The media management system of claim 16, wherein the output device comprises at least one selected from a group consisting of a video projector, a monitor, a flat panel, an audio system, a television, an LCD (liquid crystal display), a PDP (plasma display panel) and a Sony SXRD device.

23. The media management system of claim 16, wherein the display device displays a plurality of second icons, each representing and encrypted with characteristics of one of a plurality of media sources, and a plurality of window icons, each representing and encrypted with characteristics of one of a plurality of output windows and/or output devices,
wherein the system is configured for the user to select one of the second icons and apply it to one of the window icons until a desired combination configuration is realized, in which all desired second icons have been selected and applied to the window icons.

24. The media management system of claim 23, wherein the system is configured to store the desired combination configuration.

25. The media management system of claim 24, wherein the system is configured to recall the stored desired combination configuration.

26. The media management system of claim 24, wherein the system is configured to recall the stored desired combination configuration using an external control system.

27. The media management system of claim 24, wherein the system is configured to recall a stored desired combination configuration using an automated external control system which responds to preset conditions such as an emergency detection.

28. The media management system of claim 23, wherein the system is configured to realize and store a plurality of desired combination configurations.

29. The media management system of claim 28, wherein the system is configured to recall the desired combination configurations.

30. An integration system suitable for configuring a media facility, said integration system comprising:
a display device suitable for displaying at least one first icon representing a media source and at least one window icon representing an output window of an output device;
an input device suitable for selecting said at least one first icon and applying it to said at least one window icon, the input device being configured to encrypt characteristics of the media source in said at least one first icon and to encrypt characteristics of the output window and/or output device in said at least one window icon; and
a storage device suitable for storing a configuration for providing an output of the media source to an input of the output window through the integration system.

31. The integration system of claim 30, wherein the integration system is configured such that the selection of one of the at least one window icons or a media space, where the one of the at least one window icons or media space represents a computing device, enables the input device to control the computing device.

32. The integration system of claim 31, wherein the input device comprises a keyboard and mouse.
